(19) United States
(12) Patent Application Publication
(10) Pub. No.: US 2004/0027022 A1
(43) Pub. Date: Feb. 12, 2004

(54) Weir dynamos and dynamo-motors

(76) Inventor: Stanley M. Weir, Santa Cruz, CA (US)

Correspondence Address: STANLEY M. WEIR, 227 FERN STREET, SANTA CRUZ, CA, 95060, US

(21) Appl. No.: 10/216,696

(22) Filed: Aug. 12, 2002

(51) Int. Cl. H02K 31/00

(52) U.S. Cl. 310/178

(57) ABSTRACT

Back torque is nearly eliminated in dynamos by permanent magnet invarient fields inducing current flow radiated invarient magnetic fields. In motors, back electromotive force is nearly eliminated by confining motor magnet flux lines to cutting of conductors in the direction of their length. Different dynamo configurations are disclosed which provide different outputs, high-amp/low-volt DC or AC and high-volt/low-amp DC. In a preferred dynamo-motor embodiment, flux lines of rotating dynamo dual-pole ring-magnets cut through a stationary copper disc which generates alternating current. The dynamo copper disc is connected to motor stationary flat copper rings. High-amp/low-volt generated AC enters and exits the copper rings at diametrically opposite locations. Motor magnet-pairs are rotationally mounted inside the copper rings. Interaction of the magnetic fields radiated by the motor magnet-pairs with the cyclically reversing polarity fields radiated by current flow through the motor rings forces rotation of the motor magnet-pairs. The motor magnet-pairs and dynamo dual-pole magnets are mounted on a shaft and rotate in unison with it whereby shaft torque is effeciently produced.

preferred dynamo-motor embodiment, flux lines of rotating dynamo dual-pole ring-magnets cut through a stationary copper disc which generates alternating current. The dynamo copper disc is connected to motor stationary flat copper rings. High-amp/low-volt generated AC enters and exits the copper rings at diametrically opposite locations. Motor magnet-pairs are rotationally mounted inside the copper rings. Interaction of the magnetic fields radiated by the motor magnet-pairs with the cyclically reversing polarity fields radiated by current flow through the motor rings forces rotation of the motor magnet-pairs. The motor magnet-pairs and dynamo dual-pole magnets are mounted on a shaft and rotate in unison with it whereby shaft torque is effeciently produced.

### BACKGROUND INFORMATION

The force field radiated by a permanent magnet is attributed by quantum physics theory to atomic coordinated circular spin of electron charges in the third shell of atoms. Spin is an intrinsic property of an electron. The source that produces this perpetual energy is at present unknown.

Groups of ferrous and cobalt atoms are naturally arranged in “domains” within which there is atomic coordinated electron spin of substantially greater density than other elements. Size of a domain is a particle that is barely visible to the naked eye. A domain is a tiny magnet which has poles and radiates a magnetic field. A permanent magnet is produced by aligning the North-South pole axes of multidues of domains. Aligned domains of best present day high coercive force permanent magnets can not be unaligned and thereby be demagnetized except by exposure to a high temperature (400 degrees celsius), or a very strong reversing magnetic field. Dynamos and dynamo-motors of the type disclosed can be located wherever neither of these two conditions are present.

“Magnetic energy is not created. It is either stored in the permanent magnet or in the surrounding space. It cannot be used up nor destroyed.” Quote from Hitachi Magnetics Corp. Permanent Magnet Manual.

Force is a form of energy. Heretofore experiments and applications of permanent magnet force seems to have proven that the productive output of permanent magnet force is always offset by simultaneous magnet self-induced electromagnetic counter force, thwarting any net energy gain. The present invention discloses means by which permanent magnet caused counter forces can be nearly eliminated.

In the year 1831, Michael Faraday (1791-1867) glued a copper disk onto a pole end of a round permanent magnet, paper insulation intervening, and rotated them in unison around the North-South pole axis of the magnet (FIG. 1). His galvanometer with probes brushing on the disk measured a current flow between the disk's center and its circumference. His galvanometer also detected a current flow when the magnet was held stationary and the disk alone was rotated. However, when the copper disk was held stationary and the magnet alone was rotated, his galvanometer detected no current flow.

Faraday discovered a means by which electromotive force (emf) can be induced without relative motion of magnet to conductor, and a means by which relative motion of magnet to conductor does not induce electromotive force. These anomalies are explained by postulating that flux lines of a magnet rotated around its North-South pole axis do not rotate, but are stationary in the rotational reference frame of planet earth. The flux lines are also stationary when the magnet is not rotating nor moving through space. Thus it is necessary that the copper disk be rotated in order for the disc to be cut by the magnet's stationary flux lines whereby an electromotive force is induced.

Faraday by the referenced experiment also discovered a means by which electricity can be generated by an invarient magnetic field inducing an invarient magnetic field . . . a conductor disk continuously cut through by an angularly constant number of magnet flux lines which induces a current flow radiated invarient field . . . provided that the current flows radially uniformly through the disk.

To distinguish one from the other in the context of this invention disclosure, the word “generator” is a machine which generates emf by means of varient magnetic fields. A “dynamo” is a machine which generates emf by means of invarient magnetic fields.

Another anomaly of a Faraday type homopolar dynamo is that no voltage is generated by it in the rotational reference frame of the dynamo. The present inventor mounted a voltmeter on a homopolar dynamo, connecting one probe to a brass shaft that was connected to the disc center and the other probe to the periphery of the disc and rotated this assenbly in unison. A high speed frames per second camera was focused on the rotating meter display. Later the motion picture taken was slowed down and stopped so that the meter could be read. It displayed 0.0000 volts.

From this experiment was learned that a motor (or any load) will receive no power if rotated in unison with a homopolar dynamo. Therefore, a means must be provided (e.g. brushes) to transfer the energy generated by a homopolar dynamo from its rotational reference frame to another rotational reference frame (e.g. the rotational reference frame of planet earth) in order to tap the energy generated.

Homopolar type dynamos generate high amperage and low voltage whereas generators generate high voltage, low amperage. This is because flux lines of a homopolar dynamo inductor magnet cut across only short lengths of conductor in electric parallel, (e.g. the lengths of radii of a disc) whereas flux lines in commercial generators cut across long lengths of wire in coils whose segments are in electric series.

In a perfect homopolar type dynamo, the inductor field is invariant. In pratice flux line density of a symetrical permanent magnet is rarely perfectly uniform at all equal radial distances from its North-South pole axis. Nevertheless best homopolar inductor field magnets are close enough to being angularly invarient to induce current flow in a homopolar disc that is nearly angularly invarient.

For there to be forced magnetic motion between any two magnetic fields, the total number of interacting flux lines must either be increasing (attraction) or decreasing (repulsion) in the direction of motion. An angularly invarient magnetic field produced by rotating a symetrical magnet on its North-South pole axis can induce an angularly invarient field by its flux lines cutting through a conductor disc. There is no magnetic pole to which either inductor or induced invarient field can be attracted, or repulsed because the number of flux lines neither increases nor decreases in either angular direction. There are no magnetic poles in the angular direction; every positon in rotaton is the same as every other positon so there is no magnetic “incentive” to rotate. Thus there can be no back nor forward torque present.

In known commercial generators back torque opposes the drive source because inductor and/or induced magnetic fields are varient. The interaction forces of varient fields oppose the drive source.

Forward emf minus back emf is the net emf output of a dynamo. Flux lines exist only in loops. A hazzard to contend with in structuring a dynamo is return flux line generated back emf. Any conductor in an electric circuit in which a conductor moves relative to magnet flux lines induces emf. In the present invention, magnetic circuits are designed which route flux line loops so that their cuffing through and back through a conductor disc both contribute to inducing current flow in the desired “forward” direction; or back emf is greatly subdued by using magnetic circuits to direct flux lines to cut conductors at high velocity where forward emf is induced and low velocity where return flux lines induce back emf. The magnetic circuits must be symetrical, otherwise back torque is induced.

Homopolar type dynamos have been put to use in special applications where high current is needed such as welding, ship degaussing, melting ingots, firing of rail guns, etc. However, homopolar dynamos have been blocked from major electrical applications because:

1. Low-volt/high-amp (e.g. 1 volt, 5000 amps,) is not economically transmitable except over very short distances.

2. Using brushes to extract power from homopolar type dynamos plagues them with high drag and ohm resistance that substantially reduces electric output. The lowest resistance commercial brushes (silver-graphite) conduct only 100 amps per square inch of contact area and require 4 pounds of pressure per square inch. Liquid metal brushes (e.g. mercury) have been experimented with to substantially reduce drag, but the voltage drop across liquid metal uses up much of the voltage generated by a homopolar type dynamo. Homopolar dynamos to produce useful power must generate thousands of amps because they generate such low voltage and thus have little voltage to drop over brush electrical resistance and still power a load.

In a homopolar motor, current flows through the disk in a “stream” (or “streams”) between a pair (or pairs) of radially spaced brushes (FIG. 2). The flux lines which encircle the current flow stream interact with arient field magnet flux lines in the gap between magnet poles on opposite sides of the disc. The current stream radiates a varient magnetic field. There is a strong field (repulsion force) on one side of current flow and a weak field (attraction force) on the opposite side of the current flow. The disk is forced to move in the direction of the weak field. However, by so doing the disk cuts through magnet flux lines in the direction which induces back electromotive force which opposes the power supply emf.

Turning now to background of the motor part of a Weir dynamo-motor. FIG. 3 illustrates a Stefan Marinov invented “Ring & Magnet-Pair Motor”. Stefan Marinov was an Austro-Bulgarian physicist Ph.D who died Jul. 15, 1997. He conceived of numerous types of generators, dynamos and motors in which permanent magnets (or electromagnets) are employed. But only the FIG. 3 motor is known by the present inventor to be an important proven contribution to science. What herein is referred to as a “Marinov Motor” is his “ring and magnet-pair motor” invention. A Marinov Motor produces shaft torque by interaction of magnetic fields radiated by AC or pulsed DC through a conductor ring with magnetic fields radiated by a magnet-pair.

A Marinov Motor consists of a pair of bar magnets with like poles facing in opposite directions, ferrous keepers across the poles, (forming a toroid). The magnet pair are encircled by a conductor ring through which current flows between two diametrically opposite input/output locations on the ring. In different versions of the motor, the magnet-pair is stationary and the ring rotates or the ring is stationary and the magnet-pair rotates, or both magnet-pair and the ring rotate. Current is input at one location on the ring, splits as it flows through ring halves and comes together to flow out through a location diametrically opposite to where input. When AC or pulsed DC flows through ring halves, and the magnet-pair is fixed stationary, the ring can be made to rotate continously. Or when the ring is stationary and the magnet-pair is mounted for rotation, the magnet-pair can be made to continuously rotate. Or when the ring and magnet-pair are both mounted for rotation, they can be made to rotate in the same or opposite directions.

In embodiments of the present invention, a pair of half-ring magnets are preferrably substuted for the pair of bar magnets and the ferrous keepers over the poles of a Marinov Motor magnet-pair are discarded since it has been found that the motor develops more torque by so doing.

Because current flows in the same direction through opposite ring-halves of a Marinov Motor, the enclosed area within the ring, looking down on it, has two adjacent current radiated magnetic poles of opposite polarity. A north and south pole face up and a south and north pole face down.

When the ring is stationary and the magnet-pair rotates, the north poles of the magnet-pair are attracted to the south poles within the ring, and the magnet south poles to the ring's north poles while simultaneously like poles repulse each other. In the gap between magnet-pair and a stationary conductor ring, interacting magnet and current radiated flux lines produce a strong (repulsion) field in part of the gap and weak (attraction) field in another part of the gap. The magnet-pair is free to move only angularly and thus is forced angularly. Rotational force continues until after 180 degrees-of rotation, the magnetic poles center themselves relative to ring poles which occurs when the magnet pole centers are midway between where current enters and exits the ring, whereupon direction of current through the ring is reversed and the magnet-pair is forced to rotate another 180 degrees in the same direction do to momentum at time of current reversal. This action cylically repeated sustains rotation of the magnet-pair, and produces torque.

A Marinov type motor is well suited for combining with a dynamo that generates high current which a Marinov Motor needs in order for its conductor ring to radiate strong magnetic fields, and the electric resistance of the ring is very low so it can be powered by a dynamo that generates low voltage.

A Marinov Motor ring radiates inductive “proactance”. The collapsing field aids the direction of current reversal flow in the ring each time a current reversal takes place as opposed to electromagnets in commercial generators in which current reversals cause inductive reactance.

Moreover, a Marinov motor does not induce back emf which plagues all other known electric motors. In an experiment by the present inventor, a copper ring was stationary while a magnet-pair was rotated at 1400 rpm within the ring. Probes of a voltmeter were alligator clipped onto points of the ring diametrically opposite each other. The voltmeter displayed zero generated voltage across these points as the magnet-pair rotated.

As the motor magnet pair orbit around the shaft axis, their flux lines trace imaginary circles. The flux lines which cut through the motor ring go in circles through the circle shape of the flat ring. The direction of magnet flux line cutting through one half of the motor ring is in the direction that supplied current flows, and opposite to it in the other half of the motor ring. The direction of motor magnet induced current flow is perpendicular to the direction of flux line arrows and perpendicular to the direction of flux line motion. This direction is across conductor ring cross section, but there is no conductor to conduct current flow in this direction (i.e. an electrical “open”). Therefore no back emf which opposes dynamo supplied emf is induced in a Marinov type motor.

Electromagnets in commercial electric motors waste energy do to inductive reactance, hystersis, eddy currents and back emf. A Marinov Motor does not.

### BRIEF DESCRIPTION OF FIGURES OF THE DRAWING

Key to reading cross hatching:

Permanent magnets are indicated by “X” cross hatching.

Conductor (e.g. copper) components are indicated by cross hatch lines leaning right.

Ferrous (e.g. iron or steel) components are indicated by cross hatch lines leaning left.

Non conductive and non magnetic (e.g. plastic) components are indicated by dash lines leaning right.

Wherever conductor and ferrous materials are adjacent, there is insulation (e.g. coat of shellac) between them.

FIG. 1 is a perspective view of a Faraday disc dynamo.

FIG. 2 is schematic view of the direction of current flow through a homopolar motor disk.

FIG. 3 is a perspective view of a Marinov ring and magnert-pair motor.

FIG. 4 is a longitudinal cross sectional view of a first preferred embodiment of a dynamo-motor.

FIG. 5 is a lateral cross sectional view of the dynamo-motor Illustrated in FIG. 4 cut along the chain line 5 of FIG. 4.

FIG. 6 is a lateral cross sectional view of the dynamo-motor Illustrated in FIG. 4 cut along the chain line 6 of FIG. 4.

FIG. 7 is a lateral cross sectional view of the current controler in the dynamo-motor illustrated in FIG. 4 cut along chain line 7 of FIG. 4.

FIG. 8 a graphical view of the output current of the dynamo and throughput current in the motor ring of the dynamo-motor of FIG. 4.

FIG. 9 is a plan cut away view of flux lines of rotating dual pole ring magnets cutting through the stationary conductor disc of the FIG. 4 dynamo-motor.

FIG. 10 is a lateral cross sectional view of three dynamos of the type illustrated in FIG. 4 connected in electric series.

FIG. 11 is a lateral cross sectional view of three dynamos of the type illustrated in FIG. 4 connected in electric parallel.

FIG. 12 is a longitudinal cross sectional view of a cylinder type homopolar dynamo.

FIG. 13 is a longitudal cross sectional view of a second perferred embodiment of a dynamo-motor.

FIG. 14 is a lateral cross sectional view of the dynamo-motor Illustrated in FIG. 13 cut along the chain line 14 of FIG. 13.

FIG. 15 is a lateral cross sectional view of the dynamo-motor Illustrated in FIG. 13 cut along the chain line 15 of FIG. 13.

FIG. 16 is a longitudal cross sectional view of a third preferred embodiment of an invarient field dynamo.

FIG. 17 is a view of two types of coil windings around a ring magnet.

FIG. 18 is a view of a flat copper wire whose width changes periodacally along its length.

FIG. 19 is a longtitudal cross sectional view of a fourth preferred embodiment of an invarient field dynamo.

FIG. 20 is a view of square copper magnet wire wrapped around sections of a cylinder magnet and a ferrous cylinder in the dynamo illustrated in FIG. 19.

FIG. 21 is a table summerizing the types of invarient field dynamos illustrated and described.

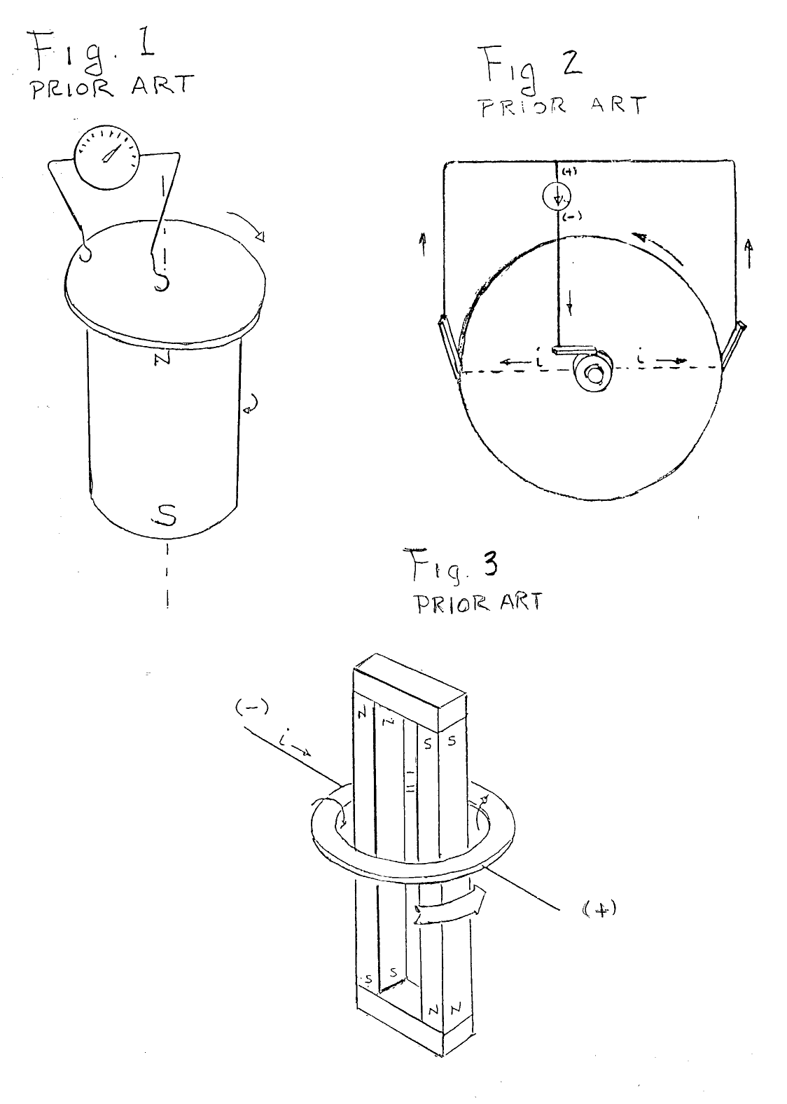

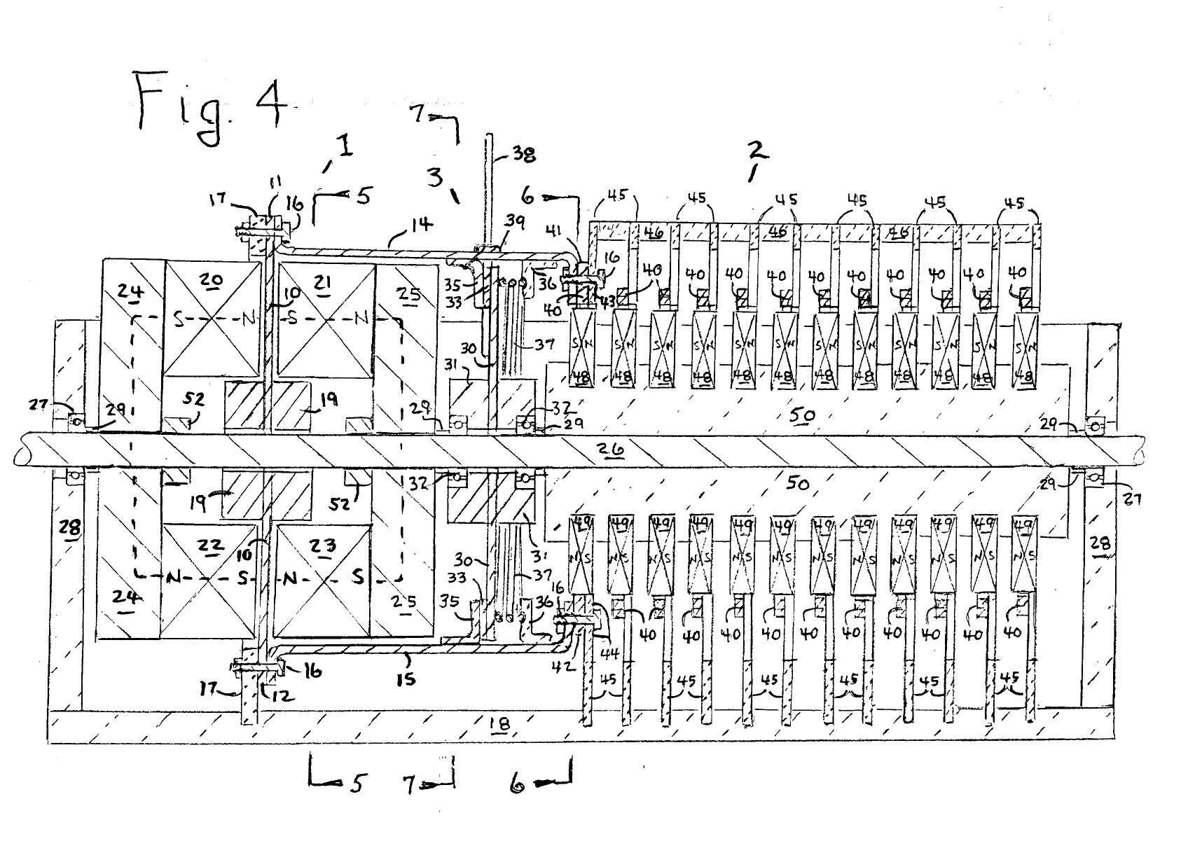

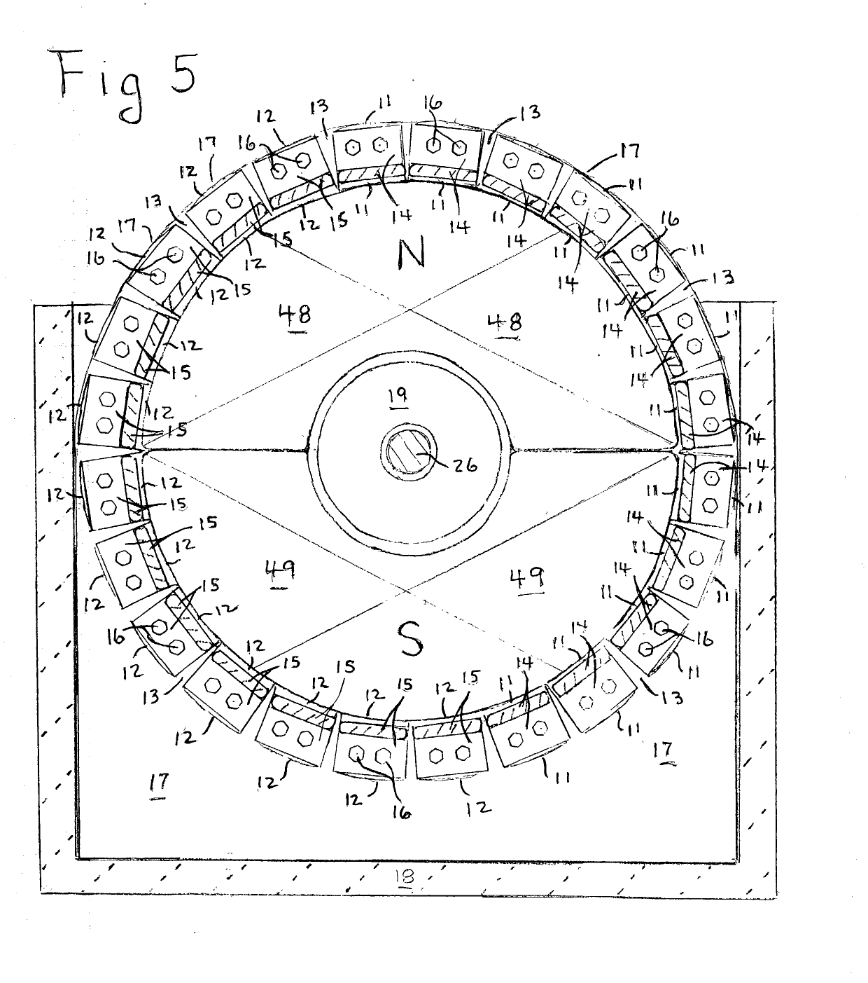

### DESCRIPTION OF THE PREFERRED EMBODIEMENTS

It is not known at present which of the embodiments of the invention is most favorable. Disclosed are a family of five invarient field dynamos which have basic method principles in common. Differences in structure of invarient field dynamos determine which of three different electrical outputs it generates: high-amp/low-volt DC, high-amp/low-volt AC, and high-volt/low-amp DC. High-amp/low-volt DC invarient field dynamos (e.g. homopolar type) have only specialized nitch market applications. The other three dynamo electric outputs have widespread potential markets and are environmentally benign. The high-amp/low-volt AC output type of dynamo is made widely useful by teaming it with a modified Marinov Motor.

In the context of the present invention disclosure the word “disk” has the standard dictionary definition: “a flat thin circular plate”, whereas the word “disc” is given the definition: “a flat thin circular plate which (relative to its circumference) has a small circular opening through its center”.

A “conductor disc” has an opening through its center large enough for a drive shaft to pass through without touching the disc.

A “ferrous disc” has a center opening which fits tightly around and is secured to a drive shaft on which it is mounted.

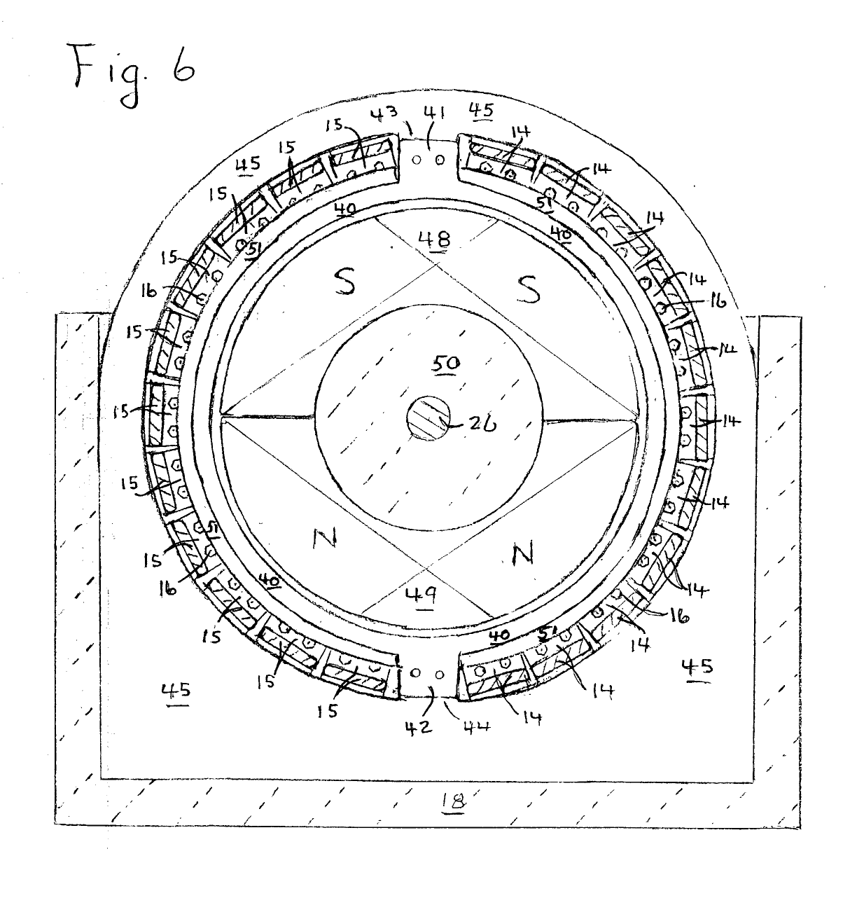

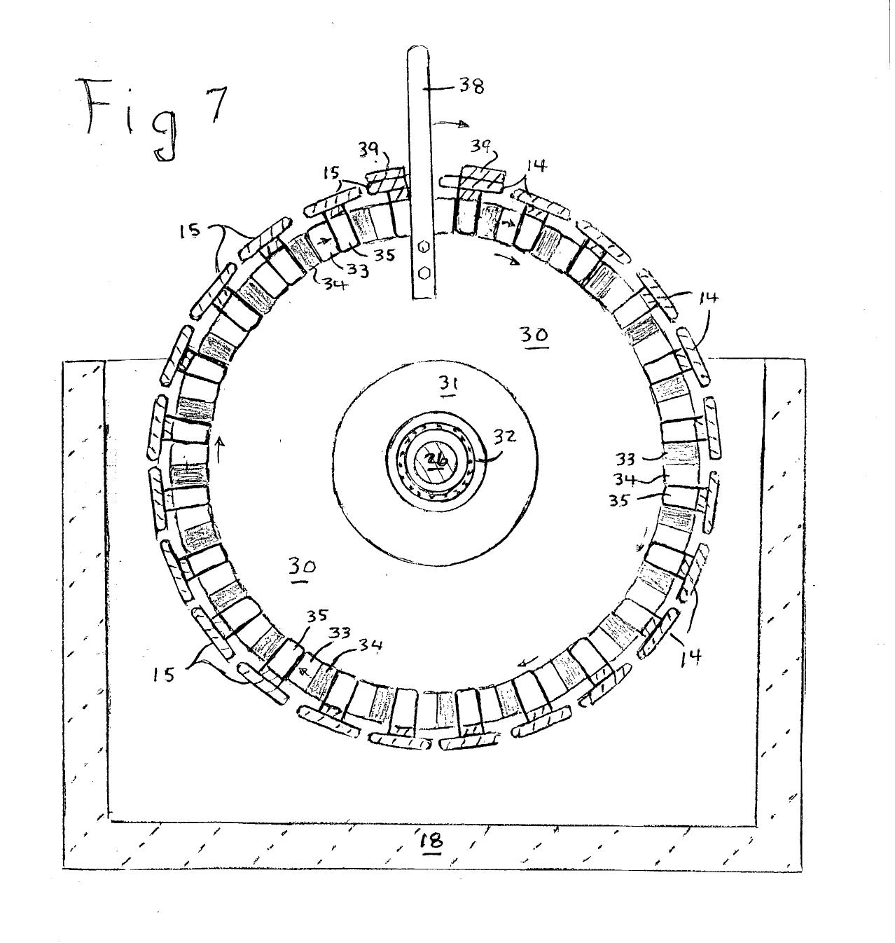

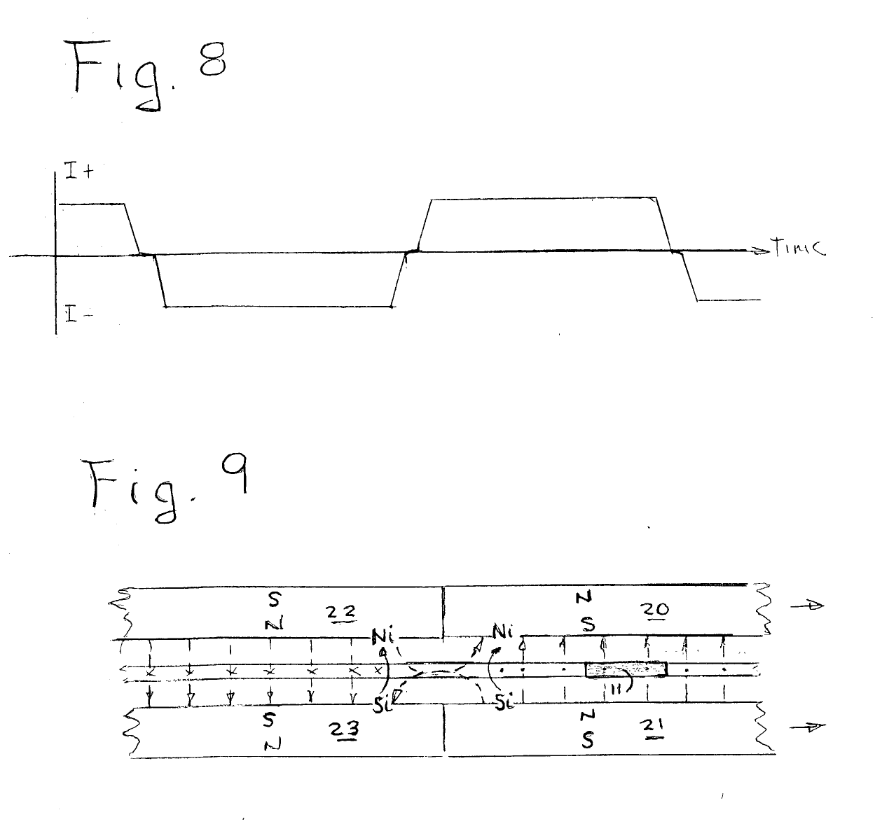

A disc which is not specified as either a “conductor disc” (e.g. copper) or a “ferrous disc” (e.g. steel) but just “disc” is a non conductor and non magnetic disc (e.g. plastic). FIGS. 4-9 illustrate a first Preferred Embodiment in which a dynamo 1 is integrated with a modified Marinov Motor 2 to produce shaft torque output. A “controler” 3 controls the amount of current supplied to the motor.

A stationary conductor disc 10 (FIG. 4) has twelve pairs of diametrically opposite extensions 11, 12 (FIG. 5) which are formed by making “V” shaped notches 13 around the periphery of the conductor disc. Twelve pairs of diametrically opposite conductor bars 14, 15 are are connected to the twelve pairs of diametrically opposite disc extensions 11, 12, and extensions 11, 12 and conductor bars 14, 15 are connected to stanchion 17 by bolts 16. Stanchion 17 is mounted in a groove in housing base 18. Conductor bar pairs 14, 15 are also connected to diametrically opposite extensions 41, 42 (FIGS. 4, 6) of flat motor conductor rings 40 of which there are twelve in electric parallel. In FIG. 4 only one pair 14, 15 of the twelve pairs of dynamo conductor bars are shown. This simplification allows basic structure to be more clearly seen.

To increase current carrying capacity of conductor disc 10 in the area around its center opening are two conductor rings 19 which are electrically connected (e.g. silver solder braized) to disc 10.

Disc 10 is in a gap between half-ring magnet pairs 20, 22 and 21, 23. Half-ring magnets 20, 22 are mounted on ferrous disc 24. Half-ring magnets 21, 23 are mounted on ferrous disc 25. Ferrous discs 24, 25 are mounted on shaft 26 which is journaled in bearings 27. Bearings 27 are mounted in housing end members 28.

A “half-ring magnet-pair” and a “dual pole ring magnet” are alike and used interchangeably in this text. Special magnetizing equipment is used to magnetize two adjacent poles on a face of a dual-pole ring magnet. The same result can be achieved by cutting in half a ring magnet which has a single pole on each face and flipping one half of the ring over.

The north pole surface of magnet half-ring 20 is directly opposite the south pole surface of half-ring magnet 21, and the south pole surface of half-ring magnet 22 is directly opposite the north pole surface of half-ring magnet 23. Magnets 20, 21, 22, 23 and ferrous discs 24, 25 are members of a magnetic circuit indicated by a dash line loop in FIG. 4. Turning now to the modified Marinov Motor (FIGS. 4, 6), there are twelve parallel conductor rings 40. Each motor conductor ring has diametrically opposite extensions 41, 42 (FIG. 6). Each motor ring is connected by its extensions 41, 42 to a pair of diametrically opposite conductor bars 14, 15, and is mounted by its two extensions on extensions 43, 44 of a stanchion 45 by bolts 16. The twelve stanchions 45 on which the twelve motor ringa are mounted are identical except that each has two diametrically opposite inner extensions 43, 44 at different degrees of the compus that match a diametrically opposite pair of disc 10 extensions. Stanchions 45 are spaced apart by spacers 46 and mounted in grooves of housing base 18.

Conductor bar-pairs 14, 15 electrically connect diametrically opposite pairs of dynamo disc extensions 11, 12 to diametrically opposite extensions 41, 42 of the motor rings 40 of which there are twelve. For example: Conductor bar 14 electrically connects a disc extension 11 to extension 41 of a first motor ring 40 and conductor bar 15 connects diametrically opposite disc extension 12 to diametrically opposite extension 42 of the firsts motor ring. Diametrically opposite extensions 41, 42 of motor rings 40 are mounted at different degrees of the compus such that they match diametrically opposite pairs of disc extensions 11, 12.

Within the motor rings 40 are pairs of half-ring motor magnets 48, 49. The half-ring magnets are mounted in circular grooves of hollow round bar 50 which is mounted on shaft 26. Like poles of the half-ring magnets 48, 49 face in opposite directions, and the center of their pole surface axes are 180 degrees apart. Other configurations of a motor magnet-pair than half-ring magnets may be used. For example, square bar motor magnet-pairs may be used, but half-ring magnets have been found to produce more torque.

A Marinov Motor produces forward torque and to a lessor extent back torque. Net torque is forward torque minus back torque. This is because current radiated polarity direction of flux lines outside a Marinov Motor conductor ring is opposite to polarity direction within the ring. Therefore, interaction of a magnet-pair flux lines with current radiated flux lines induces forward torque within the ring and back torque outside the ring. For a given amperage throughput, a ring formed of round wire radiates high flux line density within and outside the ring; the ring width is narrow and therefore both forward and back torque induced is high. A wide flat ring puts current radiated flux lines outside the ring farther distant from the magnet-pair which reduces induced back torque compared to a round wire ring conducting an equal amperage; but a wide ring radiates substantially less flux line density within the ring because the average distance of an electron in a wide flat ring is farther from the magnet-pair than in a ring made of round wire.

In order to get greater torque than a narrow or wide copper ring can provide, the present inventor performed an experiment in which a square brass wire was soldered to a square copper wire. Fifty amps were conducted through the wire-pair. The ratio of flux line density adjacent to the copper wire side away from the brass wire was substantially greater than the flux line density adjacent to the brass wire side away from the copper wire. The net flux line density between opposite sides of the laminated wires was substantially greater than the net flux line density when equal current flowed through a round copper wire or flat ring which had equal current conducting capacity. In the laminated copper/brass combination, most of the electrons flowed through the copper because copper has less electrial resistance than brass. Laminating brass to copper widens the distance between opposite sides which enables placing the back torque current radiated flux lines farther from a magnet-pair within a motor ring. The non ferrous metal pair that produces the maximum net ID to OD flux line density for a given current throughput is yet to be determined as is the optimum width of the motor ring.

In FIG. 6, the motor ring consists of a copper ring 40 with extensions 41, 42 to which is laminated non ferrous metal arcs 51 which have a higher ohm resistance than copper. Should a copper round ring or flat ring be used, the dynamo-motor works but with reduced torque.

Timing of current reversals in the motor rings for continuous motor magnet rotation is made by proper alignment connections of dynamo half-ring magnets 20. 21, 22, 23 relative to motor half-ring magnets 48, 49 on shaft 26. Motor magnets are aligned with dynamo magnets when an imaginary plane passes lengthwise through the shaft axis, and through the North-South pole axes of the motor magnets and bisects the pole surfaces of the dynamo half-ring magnets, and like poles of the dynamo and motor magnets closests to each other face in opposite directions.

Shaft collars 52 mounted on shaft 26 give added strength to holding apart magnets 20, 22 from magnets 21, 23 which magnets are strongly attracted to each other. Thereby the air gap in which disc 10 is located is held open. Shaft spacers 29 prevent lateral movement of the dynamo and motor rotors within the housing.

A current controler 3 (FIGS. 4, 7) can slow or stop the dynamo-motor by short circuiting current flow from dynamo to motor. A current short circuiting conductor disc 30 has two conductor rings 31 electrically connected to it which increases current carrying capacity of the current controler. Conductor rings 31 are mounted on bearings 32 in which shaft 26 is journaled. Mounted on the periphery of conductor disc 30 are conducor pads 33 interspersed with same thickness non conductor pads 34 (shown shaded in FIG. 7).

A conductor bracket 35 and a non conductor bracket 36 are mounted on each conductor bar. A large diameter compression spring 37 is mounted between conductor brackets 35 and the perphiery of conductor disc 30 which puts pressure of conductor pads 33 and/or non conductor pads 34 on conductor brackets 35. Rotating handle 38 clockwise brings conductor pad 33 surfaces in contact with conductor bracket 35 surfaces. The greater the overlap of the surfaces of pads 33 and conductor brackets 35, the greater is the amount of current short circuited reducing current supplied to the motor rings.

The conductor bars 14, 15 are notched out next to handle 38 to allow the handle to move angularly (FIG. 7). To compensate for the notched out material removed, conductor pieces 39 are silver soldered braised to conductor bars 14, 15 so that their current carrying capacity is not reduced by the notching out of conductive material.

In operation, shaft 26 rotation start up is powered by a drive motor (not shown). Maximum power is reached when current carrying capacities of the conductor circuits are reached. In the dynamo, flux lines of the half-ring magnets cut through the conductor disc in opposite polarity directions which induces current to flow in radially opposite directions. Between each pair of diametrically opposite disc extensions, current flows into the center of the disc from one extension and out from the disc center through its diametrically opposite extension. Current direction through each disc extension-pair reverses every 180 degrees of rotation. Total emf generated is the sum of inward and outword induced emfs between diametrically opposite disc extensions 11, 12. Dynamo generated emf voltage is doubled compared to a homopolar type dynamo of equal dimensions.

The rotating dynamo magnet inductor fields which cut through disc 10 are nearly invarient except for short intevals where polarity reversals take place. Where half-ring magnets butt up against each other, change from one invarient field to another is abrupt and virtually no current is induced.

FIG. 8 is a graphical view of current output of the dynamo which is the same as the current throughput in the motor rings. Current flows in rectangular AC waves punctuated by small time intervals when current drops to near zero. As dynamo half-rings 20, 21 rotate by extension 11 of conductor disc 10 (FIG. 9), invarient field flux line arrows pointing in a first direction induce radial current flow in extension 11 in a first direction. When magnet rotation passes ring extension 11 where half-rings butt up against each other, flux lines cut through extension 11 in opposite directions at oblique angles to the perpendicular and therefore induce little current flow through extension 11. Following this, invarient field flux lines of the rotating magnets 22, 23 point in the opposite direction to the first direction and current is induced to flow radially through extension 11 in the opposite direction to the first direction.

The inductor magnetic fields cutting through disc 10 are comprised of two nearly invarient fields of reverse polarity. The invariance is broken where opposite facing polarity half-ring magnets butt up against each other. There induced current magnetic poles “Ni” and “Si” radiate from disc 10. These poles, if stationary, would cause back torque. However, poles Ni, Si radiated from stationary disc 10 move in lock step around disc 10 with rotation of the inductor magnets 20, 21, 22, 23. The poles of the magnets and current radiated magnetic poles are fixed in space relative to each other and move through space in unison. The attraction and repulsion forces between the Ni, Si poles and magnet-pair poles remain constant; at no time do flux lines between magnet poles increase or decrease relative to each other, a condition necessary to achieve magnetically forced forward or back motion.

The full ability of the dynamo to produce current throughput is utilized. At a given moment in time DC flows uniformly through disc 10 flowing in through half of disc extensions 11, 12 and out through the other half of the disc extensions. Disc extensions are located all around the disc circumference rather than limited to only one or a few input/output locations on disc circumference as commonly practiced when brushes are used to input/output homopolar dynamo current.

A dynamo of the type described above is not a homopolar dynamo. The magnets rotate and the disc is stationary, and flux lines intentionally cut through the disc in two different directions. The dynamo disc and motor rings are in different rotational reference frames. Dynamo magnet half-rings orbit around the shaft axis. The magnets move through space and do not rotate around their North-South pole axes as in a homopolar dynamo. No brushes are needed to transfer power from one rotational reference frame to another. This type of dynamo is an induction AC high-amp/low-volt dynamo.

To increase AC frequency output through each diametrically opposite pair if dynamo extensions at a given rpm, a greater number of poles than dual pole may be employed (e.g. 6-poles of equal pole surface areas on each ring magnet face).

Even though the current generated is AC, the polarity direction of the magnetic circuit has a one-way direction unlike cores of electromagnets in generators wherein polarity direction reverses frequently (e.g. 60 hertz). Reversals of core polarity in generator electromagnets causes energy waste do to hystersis, eddy currents and inductive reactance.

In the motor, the magnetic fields radiated by motor rings interact with the motor magnet-pairs forcing their rotation. All ring magnet radiated fields contribute to force rotation of the magnet-pairs, each force phase of a ring begining and ending at a different time than other motor rings.

Each time current reverses in the motor ring, there is inductive proactance; the collapse of the field aids the direction of current reversal unlike in generators wherein reversals of current is opposed by the collapsing field causing inductive reactance.

Flux lines of the rotating motor magnet-pairs cut through the motor conductor rings in concentric circles which trace imaginary circles through the motor rings. The force of the motor magnet flux lines on electrons in the motor ring is in the direction across ring cross sections. But current flow in this direction is blocked because there is no conductor to conduct it in the induced direction (i.e. an electric “open”). Therefore no back emf is induced in the motor rings by the motor magnets.

Dynamo-motor electric circuits are short in length and conductors are large in cross section. There is no inductive reactance and no back emf in the electrically parallel circuits. Therefore ohm resistance to induced current flow is very low (micro ohms). Very high current (thousands of amps) and low voltage (e.g. 1 volt) is converted to usable shaft torque.

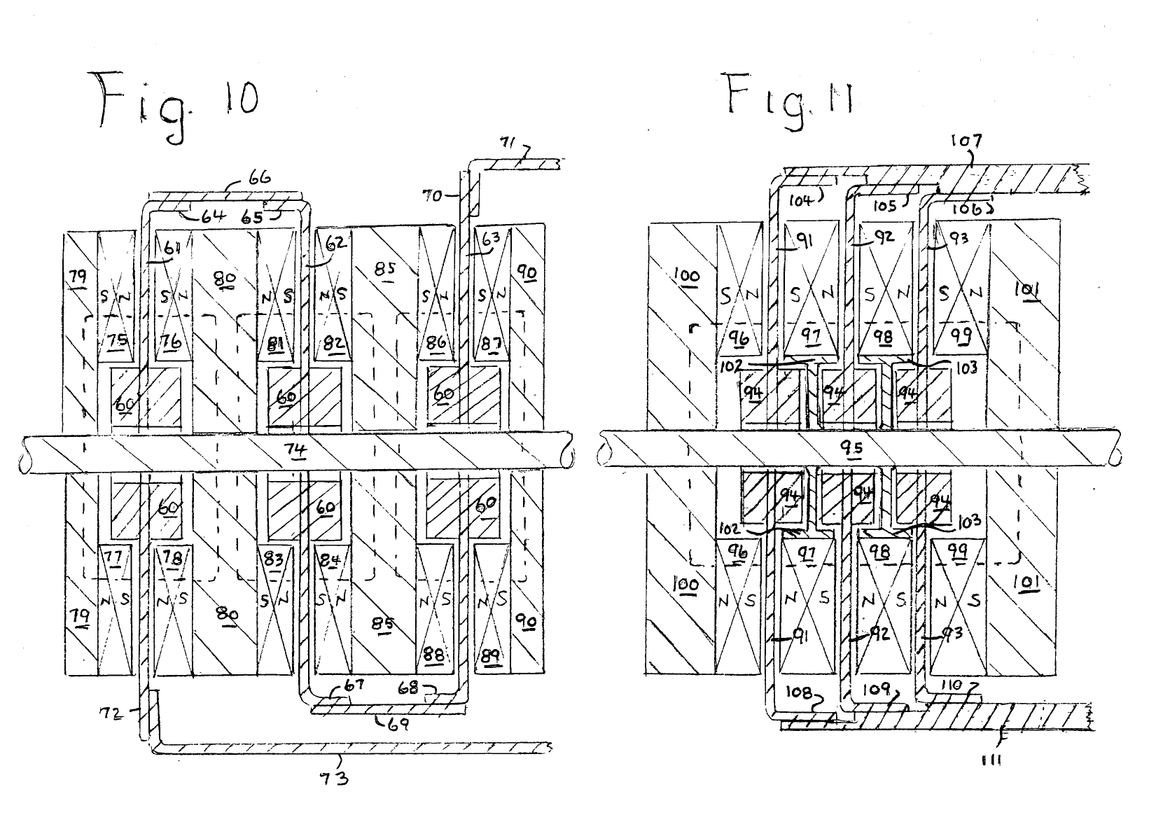

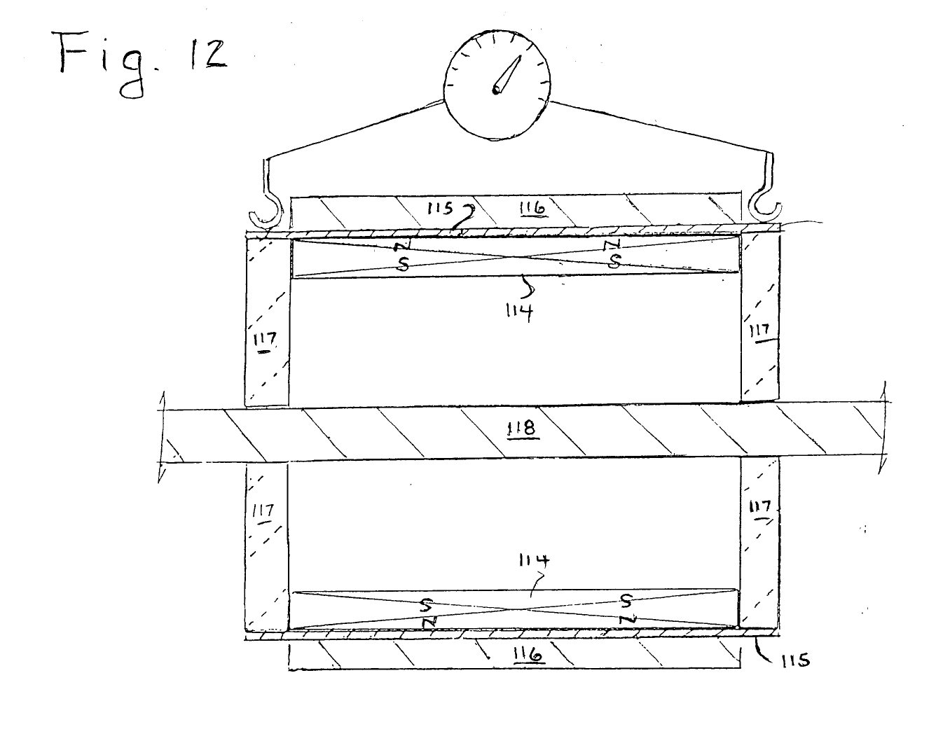

Turning now to FIG. 10, there is shown structure which illustrates how dynamo output voltage can be increased by connecting three dynamos of the type illustrated in FIG. 4 in electric series.

Three conductor discs 61, 62, 63 are held stationary (structure that holds the discs statonary is not shown). Conductor rings 60 are electrially connected to disc centers to increase current carrying capacity at the center of the conductor discs. Disc extensions 64, 65 are connected by conductor bar 66: disc extensions 67, 68 are connected by conductor bar 69; disc extension 70 is connected to dynamo terminal conductor bar 71; disc extension 72 is connected to dynamo terminal conductor bar 73. This arrangement of disc diametrically opposite disc extensions to diametrically opposite conductor bars is repeated (not shown) all around the three dynamos.

Three sets of dynamo magnets rotate in unison with shaft 74. Members of the first magnetic circuit are magnet half-rings 75, 76, 77, 78 and ferrous discs 79, 80. Members of the second magnetic circuit are magnet half-rings 81, 82, 83, 84, and ferrous discs 80, 85. Members of the third magnetic circuit are magnet half-rings 86, 87, 88, 89, and ferrous discs 85, 90. Magnetic circuit loops are indicated by dash line loops.

In operation during a first 180 degrees of magnet rotation, current is induced to flow through diametrically opposite extensions of discs 61, 63 in a first direction and in the opposite direction through diametrically opposite extensions of disc 62. During the following 180 degrees of rotation, current is reversed through the discs. This is cyclically repeated. The total emf generated is the sum of the series radially induced electromotive forces of the three dynamos. Should the direction of rotation be reversed, induced current direction is reversed.

Turning to FIG. 11, there is shown three dynamos connected in electric parallel whereby current capacity output is increased roughly threefold over a single AC high-amp/low-volt dynamo.

Three parallel conductor discs 91, 92, 93 are held stationary (means not shown). Conductor rings 94 increase current carrying capacity around the center of the conductor discs. Shaft 95 passes through openings in the conductor discs and rings. Conductor disc extensions 104, 105, 106 are connected to terminal conductor bar 107. Disc extensions 108, 109, 110 are connected to terminal conductor bar 107. This arrangement of disc diametrically opposite disc extensions to diametrically opposite conductor bars is repeated (not shown) all around the three dynamos.

The discs are in gaps between four dual pole ring magnets 96, 97, 98, and 99. Dual pole ring magnet 96 is mounted on ferrous disc 100 and dual pole ring magnet 99 is mounted on ferrous disc 101 which discs are mounted on shaft 95. Dual pole ring magnet 97 is mounted on flanged ring 102, and dual pole ring magnet 98 is mounted on flanged ring 103 which rings are mounted on shaft 95. The magnetic circuit is indicated by a dash line loop.

In operation during a first 180 degrees of magnet rotation, current is induced to flow through diametrically opposite extensions of discs 91, 92, 92 in a first direction. During the following 180 degrees of rotation, current is reversed through the diametrically opposite discs extensions. This is cyclically repeated. The current output is the sum of currents induced by all three of the electrically parallel conductor discs.

Turning now to FIG. 12, there is illustrated a cylinder homopolar dynamo. In an experiment by the present inventor, a cylinder magnet 114 radially magnetized through its wall thickness was fabricated by glueing a mosaic of arc magnets together inside a copper cylinder 115 and a steel pipe 116. This fabrication was necessary becaue there is no known source for obtaining a radially magnetized cylinder magnet. The cylinders were mounted on plastic discs 117 which were mounted on shaft 118. This assembly was rotated in unison. A voltmeter whose probes brushed on opposite ends of the copper cylinder displayed that an emf voltage was generated.

A first advantage of the cylinder homopolar dynamo over the disc type homopolar dynamo is that the velocity at which flux lines cut a conductor cylinder is substantially greater than ring magnet flux lines on average cut through a conductor disc, given equal diameters and rotational velocity. The higher the cutting velocity of flux lines, the higher the emf generated. A second advantage is that the longer the length of a cylinder homopolar dynamo, the greater is the voltage generated. This method of increasing homopolar dynamo voltage is structurally simpler than that shown in FIG. 10.

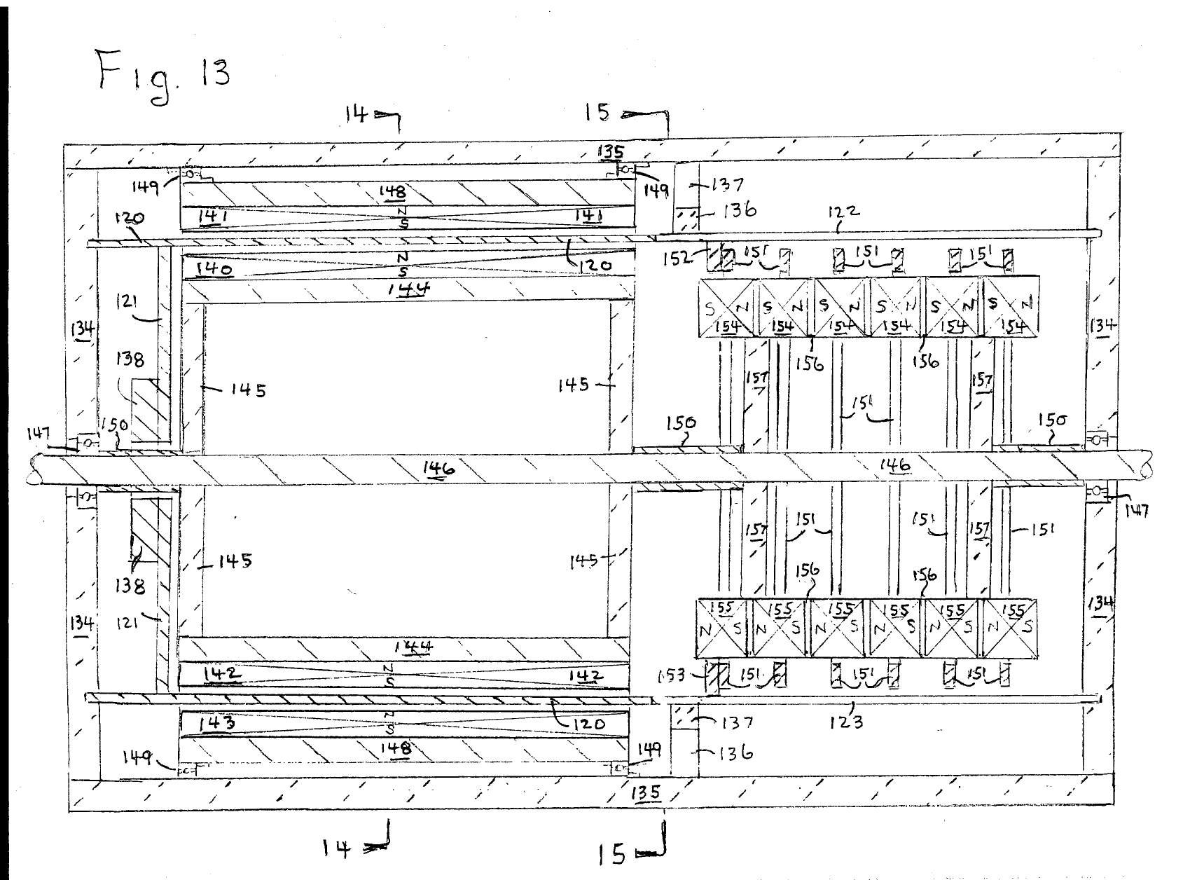

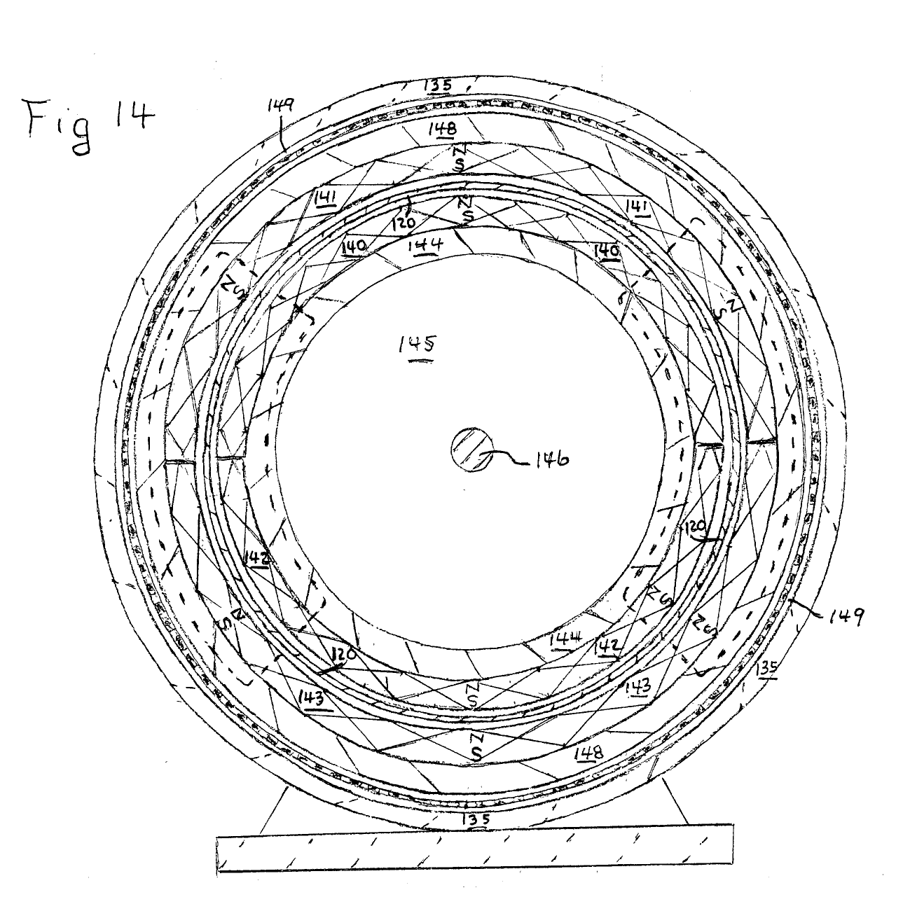

Turning now to FIGS. 13, 14, and 15, there is illustrated a second preferred embodiment of a dynamo-motor. The dynamo employed is an invarient field cylinder type AC high-amp/low volt output dynamo.

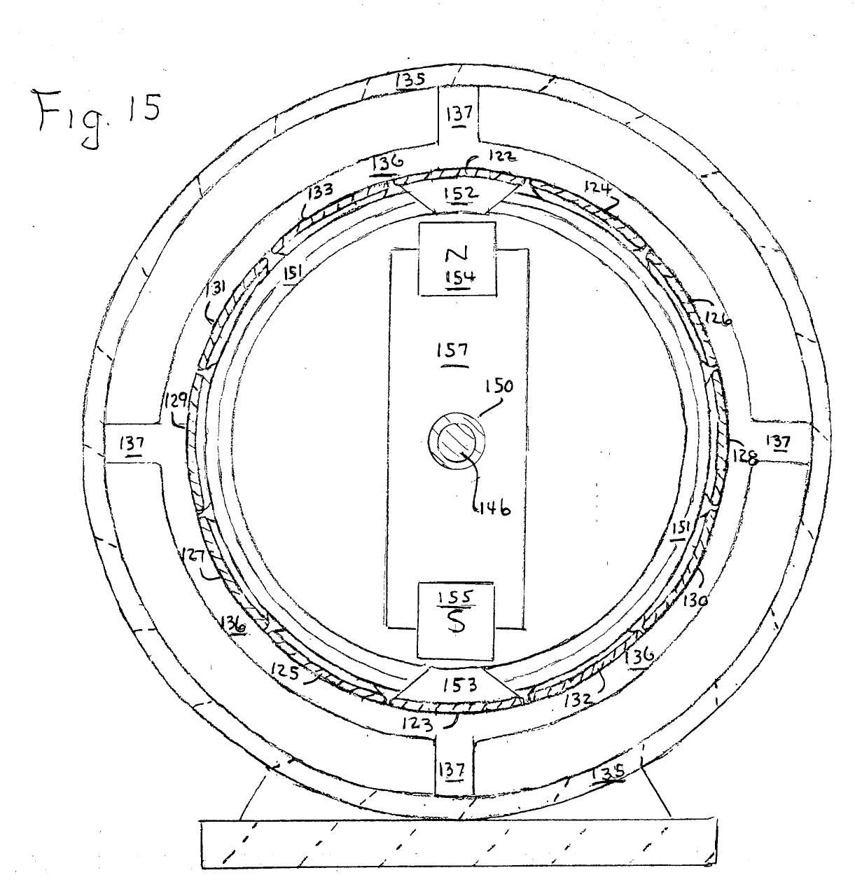

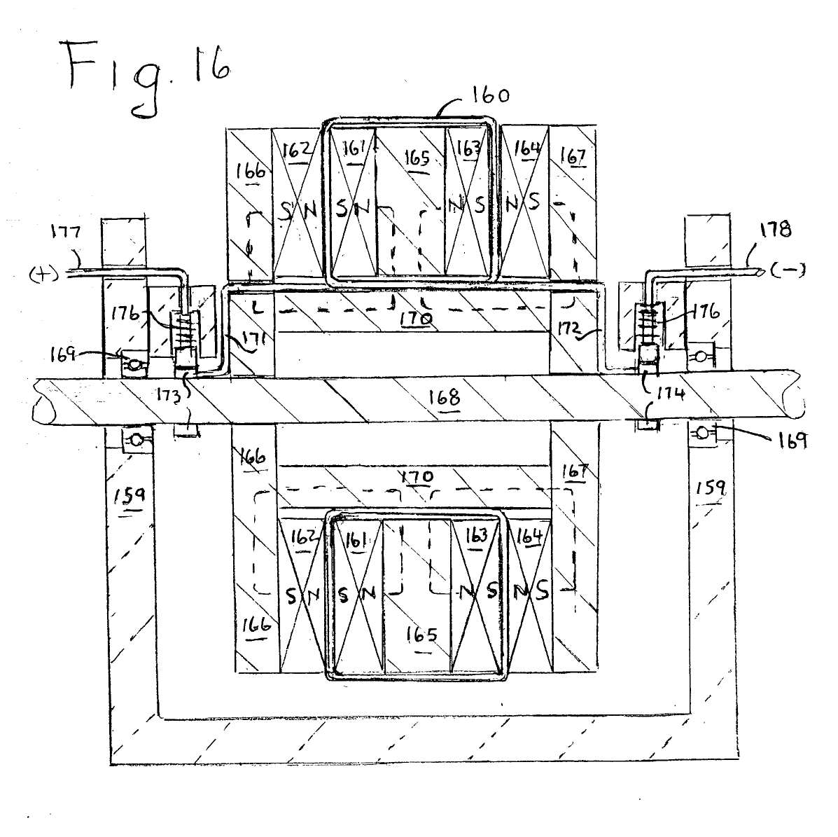

A stationary conductor cylinder 120 with one end closed by a conductor disc 121 (FIG. 13) has six pairs of diametrically opposite extensions 122/123, 124/125, 126/127, 128/129, 130/131, 132/133 (FIG. 15). The cylinder extensions are slightly arced conductors formed by making elongated slits in the right half of cylinder 120. These extensions serve as conductors which conduct current to motor conductor rings. Cylinder 120 and its extensions are mounted in circle grooves of housing round end plates 134. Housing end plates 134 are mounted in housing cylinder 135. Conductor cylinder 120 and its extensions are also supported by ring 136 and its extensions 137 which are mounted on the inner wall of housing cylinder 135 (FIGS. 13, 15). Conductor ring 138 connected to conductor disc 121 increases current carrying capacity through the area around the center of conductor disc 121.

In FIG. 13 only one pair 122/123 of six pairs of dynamo conductor cylinder extensions is shown. This simplification allows basic structure to be more clearly seen.

A pair of half-cylinder magnets 140, 142 together form an inner dual-pole cylinder magnet. Magnets 140, 142 are radially magnitized through their wall thicknesses and their like poles face in opposite directions. Another pair of half-cylinder magnets 141, 143 together form an outer dual-pole cylinder magnet. Magnets 141, 143 are radially magnetized and like poles of the two magnets face in opposite directions.

Magnets 140, 142 are mounted on ferrous cylinder 144 which is mounted on discs 145. Discs 145 are mounted on shaft 146 which is journaled in bearings 147. Magnets 141, 143 are mounted on ferrous cylinder 148 which is journaled in bearings 149. Bearings 149 are mounted on the the inner wall of housing cylinder 135.

Across a cylindrical gap in which conductor cylinder 120 is located, opposite pole faces of magnets 140, 141 face each other, and opposite pole faces of magnets 142, 143 face each other. Half-cylinder magnets 140, 141, 142, 143, and ferrous cylinders 144, 148 are members of magnetic circuits indicated by dash line loops in FIG. 14. The rotation of the inner half-cylinder magnets 140, 142 causes the outer half-cylinder magnets 141, 142 to rotate in unison with them because of their strong magnetic attraction to each other.

The motor has six parallel conductor rings 151. A motor conductor ring 151 is a lamination of copper ring with a non ferrous metal ring of higher ohm resistance surrounding it. A copper ring alone would also work, but torque output would be less for a given current throughput. Diametrically opposite segments of each motor ring are connected by a pair of conductor connectors 152, 153 to a pair of diametrically opposite extensions of cylinder 120. For example, dynamo conductor cylinder extension 122 is electrically connected to a segment of a first motor conductor ring 151 by conductor connector 152, and diametrically opposite dynamo conductor extension 123 is connected to the diametrically opposite segment of the first motor conductor ring 151 by conductor connector 153.

Mounted for rotation inside the motor rings are sets of square bar motor magnets 154, 155 whose like poles face in opposite directions. Non magnetic spacers 156 are mounted between the motor magnets. Magnets 154, 155 and spacers 156 are mounted on two supports 157 which are mounted on shaft 146. Shaft spacers 150 prevent lateral movement of the dynamo-motor rotor in the housing.

Timing of current reversals in the motor rings for continuous rotation of the motor magnet pairs is made by alignment connections of square bar motor magnet-pairs 154, 155 relative to dynamo half-cylinder magnets 140, 141, 142, 143 on shaft 146. Motor magnets are aligned with dynamo magnets when an imaginary plane passes lengthwise through the shaft axis, and through the North-South pole axes of the motor magnets and bisects the pole surfaces of the dynamo half-cylinder magnets, and polarity of each motor magnet pole that faces the dynamo is the same as the nearest dynamo pole closest to the shaft axis.

A current controler (not shown) like that which is illustrated in FIG. 7 may also be made integral to a cylinder AC dynomo-motor.

The operation of this second dynamo-motor embodiment is essentially the same as that of the first dynamo-motor embodiment disclosed (FIGS. 4-9). AC power is supplied by the dynamo to the motor rings and the shaft is driven by interaction of cyclically reversing polarity varient fields radiated from the motor rings with varient fields radiated by the motor magnet-pairs. The cylinder type AC dynamo has the advantage over the disc type AC dynamo in that it generates higher voltage for a given diameter and rotation velocity. A disadvantage is that rotation of the outer dynamo magnets 141, 143 requires a second set of bearings 149.

Dynamo-motor rotation velocity is limited by mechanical rotation capability, and capacity of the dynamo-motor circuit to conduct electricity without over heating. Heat raises circuit resistance which causes a drop in current flow and a reduction in rpm. A load of appropriate torque consumption or a govenor may be engaged to keep velocity from exceeding maximum operating rpm. The governor, for example by using short circuiting action (FIG. 7) stabilizes rotation at motor maximum rpm and torque.

Dynamo-motor torque may be increased by: (1) increasing rpm up to maximum current carrying capacity, (2) increasing electric circuit current carrying capacity, (3) reducing leakage from magnetic circuits, (4) reducing width of gaps between magnet poles and conductors by higher precision manufacturing, (5) increasing magnet size and strength, and (6) employing multiple motor modules. The desired maximum rated motor torque can be designed by manipulating up or down these variables.

The above disclosed embodiments of dynamo-motors convert largely unusable dynamo induced AC high-amp/low-volt output to usable shaft torque. Following is disclosed invarient field dynamo embodiments that output high-volt/low amp DC which has widespread applications.

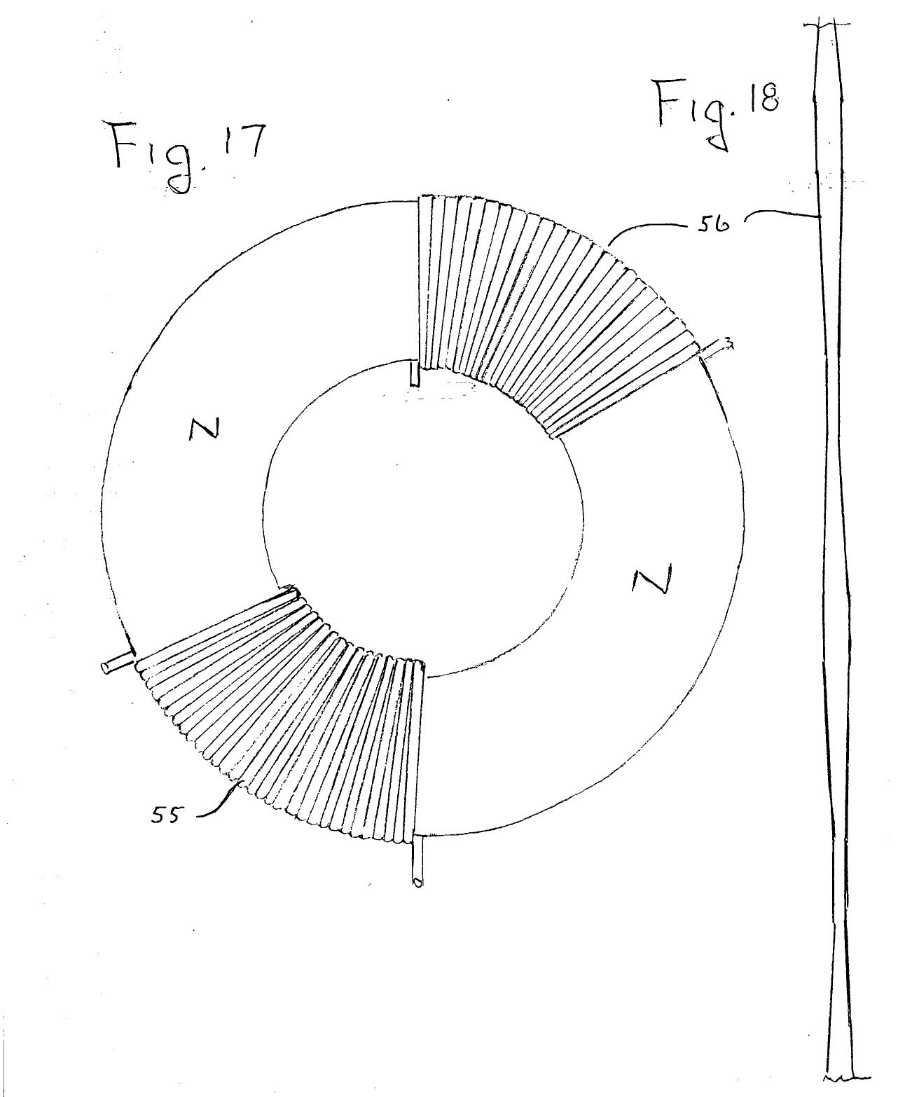

Referring to FIGS. 16, 17, 18, a conductor toroid coil 160 is coiled around ring magnets 161, 163 and ferrous ring 165. Two opposite parallel sides of toroid coil 160 are sandwiched between ring magnet-pair 161, 162 and ring magnet-pair 163, 164. Like poles of magnet-pair 161, 162 and magnet-pair 163, 164 face in opposite directions. Ring magnet 162 is mounted on ferrous disc 166 and ring maget 164 is mounted on ferrous disc 167. Ferrous discs 166 and 167 are mounted on shaft 168 which is journaled in bearings 169 that are mounted in the dynamo housing 159. A thick wall ferrous cylinder 170 connects ferrous disc 166 to ferrous disc 167. There is a small gap between the inside diameters of rings 161, 162, 163, 164, 165 and the outside diameter of ferrous cylinder 170 to accomadate turns of toroid coil 160. Toroid coil end segments 171, 172 pass through openings in ferrous discs 166, 167 and connect to conductor slip-rings 173, 174 which are mounted on shaft 168.

Magnets 161, 162, ferrous ring 165, ferrous disc 166 and ferrous cylinder 170 are members of a first magnetic circuit. Magnets 163, 164 ferrous ring 165, ferrous disc 167, and ferrous cylinder 170 are members of a second magnetic circuit. These magnetic circuits are indicated by dash line loops in FIG. 16.

The assembly of parts 160-174 are rotated in unison by a drive motor (not shown) connected to shaft 168. Brushes 175 are pressed against slip rings 173, 174 by springs 176. Dynamo terminal wire outputs 177, 178 are connected to a load (not shown).

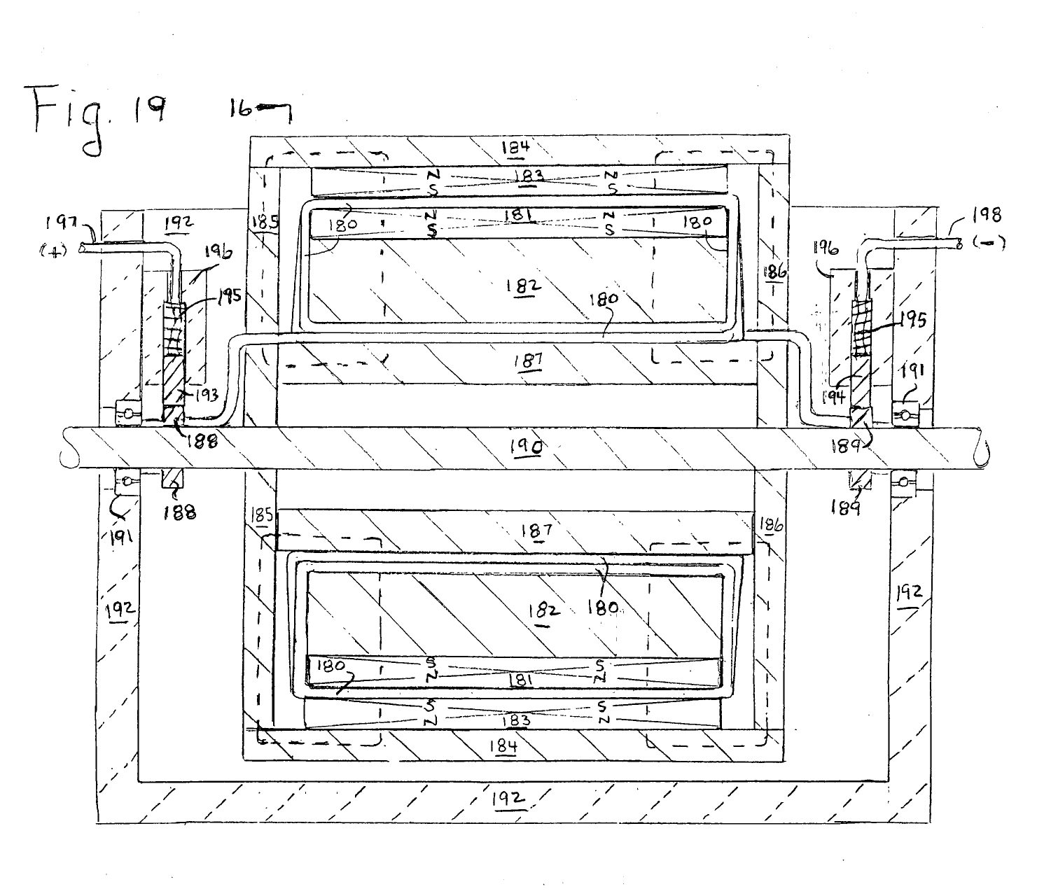

FIG. 17 illustrates commercially available magnet wire 55 wrapped around a ring magnet and a specially shaped magnet wire 56 wrapped around another part of a ring magnet. Toroid coil 160 uses the 56 type magnet wire which is a flat wire that has tapered segments interspesed with straight segments (FIG. 18). Wire 56 when wrapped around a ring magnet lies flat on its pole face surfaces, its tapering segments side by side which simulates a disc on each side of the magnet. When magnet invarient fields induce current to flow in a 56 wire wrapped toroid, it radiates an invarient field which prevents generation of back torque. Commercial magnet wire 55 is not used because overlays itself bunching up as it wraps around a ring magnet's inside diameter which causes the gap between magnets to be wider. This lowers the induced emf, and causes aberrations in the invariance of the induced field.

In operation, the ring magnets rotate around their North-South pole axis. Therefore, their flux lines are stationary and cut through rotating wire 56 segments of toroid coil 160. A voltage is generated across each coil turn segment in a gap between ring magnet pair 161, 162 and ring magnet pair 163, 164. These coil segments are in electric series and thus induced voltages across them are additive. The coil output is high-volt/low-amp DC. No voltage is generated across ends of the toroid coil in its rotational reference frame. To extract energy from the dynamo, a meams such as brushes is necessary to bring it into a different rotational referance frame (e.g. that of planet earth).

Back emf is induced in the FIG. 16 Toroid DC Dynamo because flux lines cut through coil segments in one direction then cut back through other segments of the coil in the opposite direction. However, forward induced voltage is substantially greater than back induced voltage because the velocity of flux line cutting coil segments where forward voltage is induced (between ring magnets) is substantially greater than where return flux lines cut through coil segments (between ferrous cylinder 170 and ferrous ring 165).

There is no inductive reactance generated by flux lines radiated from the toroid coil when the dynamo rotates at a constant rpm (a steady flow of DC creates neither an expanding nor contracting magnetic field). During dynamo acceleration or deceleration there is inductive reactance which is subdued because there is competition for controling the polarity of ferrous core 165 between ring magnets 161, 163 and the field radiated by current flow through toroid wire 160.

Brush size and drag needed to conduct current from the Toroid DC Dynamo is minute compared to a disc type homopolar dynamo. Amperage conducted to/from a homopolar type dynamo is huge (thousnads of amps). Amperage brush conducted to/from a Torid DC Dynamo is low (e.g. 20 amps) so that brush size can be small and total brush pressure on slip rings also small. Furthermore the voltage drop across the brushes is small compared to the high voltage generated by this type of dynamo.

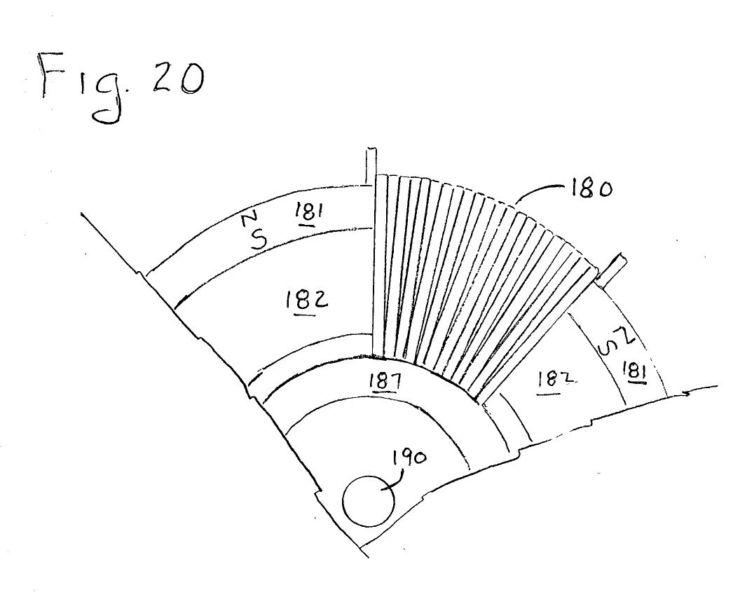

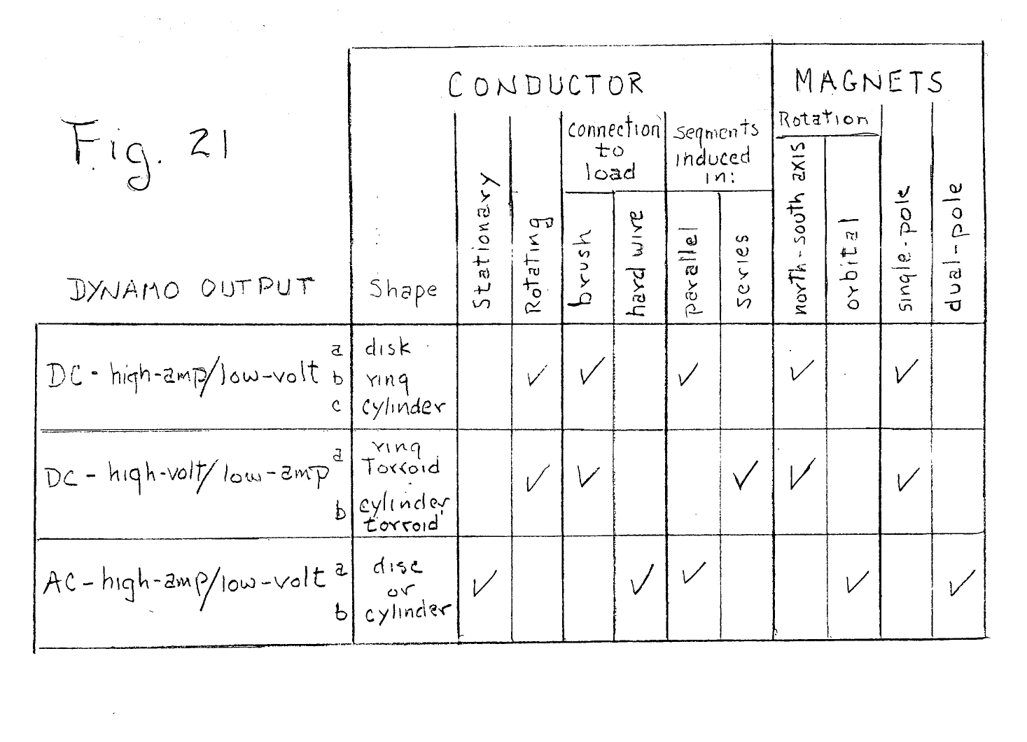

FIGS. 19 and 20 illustrate the cylinder type of a Toroid DC Dynamo. A toroid coil 180 is wrapped around a cylinder magnet 181 and a thick wall ferrous cylinder 182. The coil wire is commercially available square (or round) magnet wire. Magnet wire is copper wire coated with an insulater. Encircling the toroid coil 180 is a second cylinder magnet 183. Cylinder magnet 183 is mounted on the inside wall of ferrous cylinder 184 which is mounted on ferrous discs 185, 186. Ferrous discs 185, 186 are mounted on shaft 190. A ferrous cylinder 187 connects disc 185 to disc 186. The cylinder magnets are magnetized through their wall thickness and like poles face in the same direction,

Magnets 181, 183, ferrous cylinders 182, 184, 187 and ferrous discs 185 and 186 are members of magnetic circuits indicated by dash line loops in FIG. 19.

Opposite end segments of the toroid coil pass through openings in ferrous discs 185, 186 and are connected to slip rings 188, 189 which are mounted on shaft 190 insulation intervening. The shaft is journaled in bearings 191 which are mounted in the dynamo housing 192. Brushes 193, 194 are pressed against the slip rings by springs 195. The brushes are slidably mounted in brush housings 196 which are mounted on the dynamo housing 192. Connected to brushes 193, 194 are dynamo terminal wires 197, 198.

In operation, a cylinder DC Toroid Dynamo is essentially the same as a ring DC Torroid Dynamo.

FIG. 21 summarizes characteristics of invarient field permanent magnet dynamos. 1a and 1b are Faraday type homopolar dynamos. 1c, 2a, 2b, 3a and 3b are Weir invarient field dynamos.

In general the following applies to all the embodiements above described:

Dynamo or dynamo-motor rotation is opposed by: (1) inertia, (2) friction of bearings and brushes (if used), (3) electrial resistance to current flow, and (4) windage. However, rotation is nearly unopposed by back torque, back emf and inductive reactance. Furthermore in magnetic circuits of the present invention, flux line polarity direction does not change and therefore there are no magnetic hystersis nor eddy current energy losses which in commercial generators and motors are present do to magnetic polarity reversals in magnetic circuits.

All embodiments have considerable rotating mass providing flywheel momentum which stores the dynomotor's continuous output of power to provide rapid acceleration when engaged to power a load. Very high rotational velocities (over 50 thousand rps) have been achieved by using magnetic bearings. Super-conductors may also be used to vastly increase circuit current carrying capacity resulting in greater power output. Ultra high rotation velocity and super-conductors taken together may provide dynamos and dynamo-motors of extroadinary power.

North and South poles have been shown on the figures of the drawing. Polarity of the magnet poles if all reversed at once, the dynamos and dynamo-motors would work as well.

While the present invention has been described with reference to the particular illustrative embodiements, it is not to be restricted by those embodiments as a person skilled in the art can devise modifications without departing from the scope and principles of the present invention whose basic methods and principles are stated by the appended claims:

1. The method of generating high-amp/low volt DC consisting of; sandwiching a conductor cylinder between two cylinder magnets, or one cylinder magnet and a ferrous cylinder, wherein a cylinder magnet is magnetized radially through its wall thickness and like poles of cylinder magnets face in the same direction, and mounting the conductor cylinder on discs which are mounted on a shaft, and rotating this assembly in unison around the shaft axis by a drive power source, and drawing power from the dynamo by brushes sliding on circumferences of opposite ends of the conductor cylinder.

2. The method of generating high-volt/low-amp DC consisting of:
a) mounting a pair of ring magnets on opposite sides of a ferrous ring, like poles of the magnets facing in opposite directions;
b) wrapping magnet wire around these magnets and ferrous ring to form a tightly wound toroid;
c) mounting a second pair of ring magnets outside the torroid with their pole surfaces facing pole surfaces of magnets inside the toroid, opposite poles facing each other across the magnet wire gap;
d) mounting each outer magnet on a ferrous conductor disc which is mounted on a shaft and connecting the two ferrous discs by a ferrous cylinder extending through the aperture in the center of the toroid;
f) connecting the two wire ends of the toroid each to a different slip ring mounted on the shaft insulation intervening;
g) rotating the above components in unison by a drive source;
h) drawing power from the toroid dynamo by brushes sliding on the slip rings;

3. The dynamo of claim 2 in which the magnet wire has tapered segments and straight segments wherein it lies flat one layer thick, tapered segments side by side across the pole faces of the ring magnets around which it is wrapped.

4. The method of generating high-volt/low-amp DC consisting of:
a) mounting a cylinder magnet on a thick wall ferrous cylinder, the magnet magnetized through its wall thickness;
b) wrapping magnet wire around this magnet and ferrous cylinder to form a tightly wound toroid wherein segments of wire turns extend through the length of the ferrous cylinder;
c) mounting a second cylinder magnet outside the toroid, the cylinder magnet magnetized through its wall thickness and mounting this magnet inside a ferrous cylinder and wherein opposite poles of the cylinder magnets face each across the toroid wire gap;
d) mounting the outer ferrous cylinder on two ferrous discs which are mounted on a shaft, and connecting the two ferrous discs by a ferrous cylinder extending through the aperture in the center of the toroid;
e) connecting the two wire ends of the toroid to slip rings mounted on the shaft insulstion intervening;
f) rotating the above components in unison by a drive source;
g) drawing power from the toroid dynamo by brushes sliding on the slip rings;

5. The method of generating high-amp/low-volt AC consisting of mounting a stationary conductor disc in a gap between a pair of rotating dual pole ring magnets wherein opposite pole surfaces of the magnets face each other across the gap, and mounting each dual pole magnet on a ferrous disc which is mounted on a shaft, and rotating the magnets, ferrous discs and shaft in unison by a drive source, and drawing power from the dynamo by electric connection with a pair, or pairs, of diametrically opposite extensions of the conductor disc.

6. The method of generating high-amp/low volt AC consisting of mounting stationary a conductor cylinder with one end closed by a conductor disc wherein the conductor cylinder is in a gap between a pair of dual pole cylinder magnets radially magnetized with opposite pole surfaces facing each other across the gap, and mounting the inner cylinder magnet on a ferrous cylinder which is mounted on discs that are mounted on a shaft, and mounting the outer cylinder magnet inside a ferrous cylinder which is bearing mounted on the inside wall of a stationary cylinder, and rotating the magnets, ferrous cylinders, discs and shaft in unison by a drive source and drawing power from the dynamo by electric connection with a pair, or pairs, of diametrically opposite extensions of the open end of the conductor cylinder.

7. The dynamos of claim 5 or 6 in which conductor disc or cylinder extensions completely encircle the periphery of the disc, or cylinder, and all diametrically opposite extension pairs are connected to a load, or loads in parallel which have equal or nearly equal impedance.

8. The dynamos of claims 5 and 6 wherein conductor rings are electrically connected to opposite sides of conductor discs in the areas around disc centers whereby current carrying capacity is increased in areas around disc centers.

9. The dynamos of claims 5 and 6 wherein inductor magnets have more poles on a surface than two.

10. The dynamo of claim 5 combined with a Marinov type motor on a common shaft and in which magnet-pairs are rotatably mounted within stationary conductor rings wherein diametrically opposite extensions of the dynamo disc are electrically connected to diametrically opposite extensions of the motor conductor rings, and timing of current reversals in the motor rings for continuous rotation of the magnets is by alignment connection of dynamo magnets relative to motor magnets on the shaft wherein an imaginary plane lengthwise through the shaft axis and north-south axes of the motor magnets bisects the pole surfaces of the dynamo dual pole magnets, and wherein poles of the motor magnets and dual-pole magnets which face each other are of opposite polarity, and wherein AC is supplied by the dynamo to the motor rings and the shaft is driven by interaction of cyclically reversing polarity varient fields radiated from the motor rings with varient fields radiated by the motor magnet-pairs.

11. The dynamo of claim 6 combined with a Marinov type motor on a common shaft and in which magnet-pairs are rotatably mounted within stationary conductor rings and wherein diametrically opposite extensions of the dynamo cylinder are electricaly connected to diametrically opposite extensions of the motor conductor rings, and timing of current reversals in the motor rings for continuous rotation of the magnets is by alignment connection of dynamo magnets relative to motor magnets on the shaft wherein an imaginary plane lengthwise through the shaft axis and north-south pole axes of the motor magnets bisects the pole surfaces of the dynamo dual pole cylinder magnets, and wherein the pole polarity of each motor magnet facing the dynamo is the same polarity as the nearst inner most pole of a dual pole cylinder magnet, and wherein AC is supplied by the dynamo to the motor rings and the shaft is driven by interaction of cyclically reversing polarity varient fields radiated from the motor rings with varient fields radiated by the motor magnet-pairs.

12. The dynamo-motor of claims 10 and 11 wherein motor magnets are square bar magnets, or round bar magnets, or dual pole ring magnets.

13. A Marinov type motor whose conductor ring consists of a lamination of non conductor metals in which the lower resistivity metal ring is inside the higher resistivity ring.

14. In combination with the dynamo-motors of claims 10 and 11, a current controler consisting of a conductor disc to which is connected an array of conductor pads interspersed with non conductor pads that encircle the periphery of the disc, and connected around the center of the conductor disc a conductor ring, and mounted inside the conductor ring bearings which ride on the dynamo-motor shaft, and mounting at an equal distance from the dynamo on each of the conductors that conduct current to/from dynamo and motor, a conductor bracket and a non conductor bracket spaced apart, and a large diameter compression spring between the non conductor brackets and the conductor disc periphery, and a handle mounted on the conductor disc for rotationally bringing the conductor pads in or out of contact with the conductor brackets.

15. The method of increasing claim 5 dynamo output voltage consisting of electrically connecting two or more claim 5 dynamos in electric series.

16. The method of increasing claim 5 dynamo output amperage consisting of electrically connecting two claim 5 dynamos in electric parallel.

17. The method of generating different electric outputs by invarient field dynamos consisting of the following in common basic method principles:
a) rotating symetrical generally angular invarient permanent magnet fields and directing their flux lines by unidirectional magnetic circuits to cut generally perpendicular through symetrical conductors wherein the induced current radiates invarient fields, and wherein magnet flux lines and induced current radiated flux lines eminate within different rotational reference frames;
incorporated with:
b) the method of claim 1, whereby high-amp/low-volt DC output is generated, or
b) the method of claim 2, or claim 4 whereby high-volt/low-amp DC is generated, or
b) the method of claim 5, or claim 6 whereby high-amp/low-volt AC is generated.
